(19) United States
(12) Patent Application Publication
(10) Pub. No.: US 2006/0145975 A1
(43) Pub. Date: Jul. 6, 2006

(54) Method and system for displaying an image

(75) Inventors: Jeffrey Matthew Kempf, Dallas, TX (US); Daniel J. Morgan, Denton, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/031,204

(22) Filed: Jan. 6, 2005

(51) Int. Cl. G09G 3/34

(52) U.S. Cl. 345/84

(57) ABSTRACT

A method for displaying an image using a digital micromirror device having a plurality of mirrors operable to assume a plurality of positions is provided. The method includes receiving a plurality of numbers representing a respective plurality of pixels that form a plurality of dither patterns. Each dither pattern is a particular portion of the image to be displayed and each pixel is represented by a particular number. The method also includes assigning, to each number, an address identifying a particular one of the plurality of mirrors in a particular position. The address is unique among the addresses assigned to each of the plurality of numbers. The method also includes displaying the dither patterns one after another in a predetermined frame time period using the digital micromirror device. The dither patterns are displayed by showing each pixel on a display according to the number representing the pixel. Each pixel is shown using the particular mirror in the particular position identified by the address that is assigned to the number.

### TECHNICAL FIELD OF THE INVENTION

This invention relates generally to visual displays and more particularly to a method and system for displaying an image.

### BACKGROUND OF THE INVENTION

Television displays and other types of displays often receive a data stream that is decoded by a decoder. Often, such decoders possess inadequate resolution for high resolution displays. For example, eight bit decoders may be utilized where twelve or fourteen bit decoders would be more desirable.

This problem of inadequate bit resolution is exacerbated by other processing steps used in digital light processing systems. For example, to account for the non-linear response of a cathode ray tube, television signal images traditionally have a non-linear transfer function applied, and the non-linear response is provided as the input signal. This non-linear function is referred to as a gamma correction curve. However, in linear devices such as Digital Light Processing (DLP) Systems available from Texas Instruments, a de-gamma function may need to be applied to the incoming pixel stream to correct the unneeded gamma correction.

Because of the non-linear nature of the gamma and the de-gamma curves, linear devices such as the DLP system may require a finer grayscale resolution of approximately 14-16 bits at the low end of the grayscale curve. However, some optical semiconductors that are used in DLP systems, such as the Digital Micromirror Device (DMD™) available from Texas instruments, may have a grayscale resolution limit of 8-10 bits. To bridge the gap in resolution, mechanical and electronic dithering may be used to achieve the perception of 14-16 bit grayscale resolution. Mechanical and electronic dithering may result in images that have clumped portions and/or frequency noises that are undesirable for certain types of images, which lower the perceived quality of the image.

### SUMMARY OF THE INVENTION

According to one embodiment, a method for displaying an image using a digital micromirror device having a plurality of mirrors operable to assume a plurality of positions is provided. The method includes receiving a plurality of numbers representing a respective plurality of pixels that form a plurality of dither patterns. Each dither pattern is a particular portion of the image to be displayed and each pixel is represented by a particular number. The method also includes assigning, to each number, an address identifying a particular one of the plurality of mirrors in a particular position. The address is unique among the addresses assigned to each of the plurality of numbers. The method also includes displaying the dither patterns one after another in a predetermined frame time period using the digital micromirror device. The dither patterns are displayed by showing each pixel on a display according to the number representing the pixel. Each pixel is shown using the particular mirror in the particular position identified by the address that is assigned to the number.

Some embodiments of the invention provide numerous technical advantages. Some embodiments may benefit from some, none, or all of these advantages. For example, in one embodiment of the invention, the noise characteristic of an image displayed in a frame period can be controlled by synchronizing the mechanical and electronic dithering. In another embodiment, clumping may be reduced.

Other advantages are readily apparent to those of skill in the art.

### BRIEF DESCRIPTION OF THE DRAWINGS

For a more complete understanding of embodiments of the invention, reference is now made to the following description, taken in conjunction with the accompanying drawings, in which:

FIG. 1 is a block diagram showing portions of a light processing system according to the teachings of the invention;

FIG. 2 is a schematic diagram illustrating example address values for pixels that form an image to be displayed in a frame time;

FIG. 3A is a schematic diagram illustrating example address values for pixels that form a first subframe of the image to be displayed in a frame time;

FIG. 3B is a schematic diagram illustrating example address values for pixels that form a second subframe of the image to be displayed in a frame time; and

FIG. 4 is a flowchart illustrating one embodiment of a method for synchronizing electrical and mechanical dithering.

### DETAILED DESCRIPTION OF SOME EMBODIMENTS OF THE INVENTION

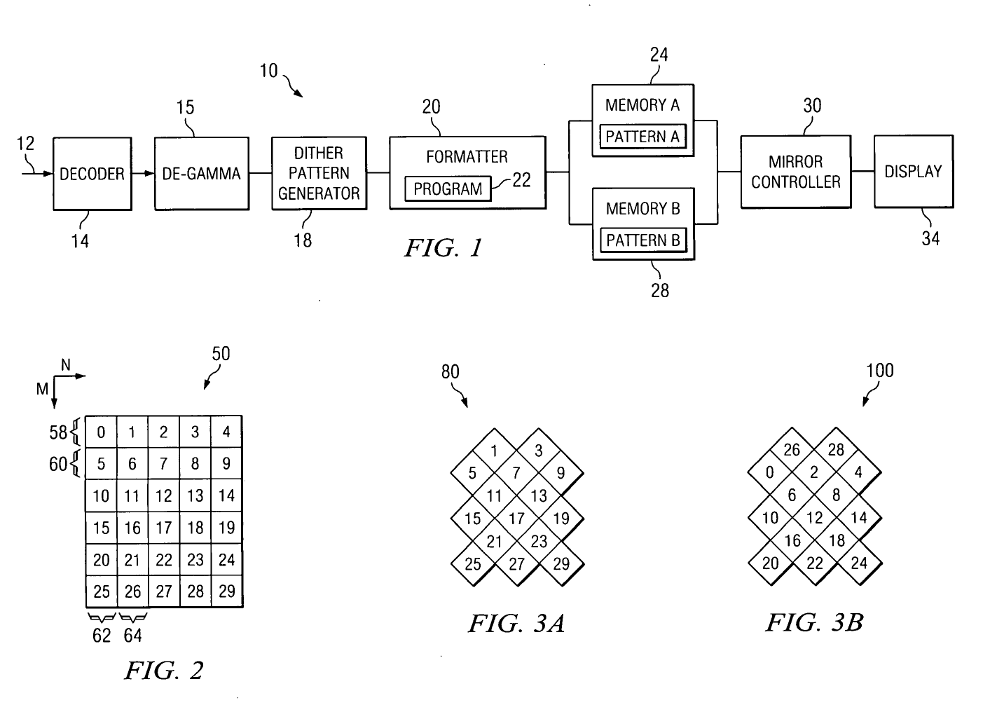

Example embodiments of the invention and its advantages are best understood by referring to FIGS. 1 through 4 of the drawings, like numerals being used for like and corresponding parts of the various drawings.

FIG. 1 is a block diagram of a light processing system 10 according to the teachings of the present invention. One example of system 10 is a DLP system, which is a liner display system. System 10 receives a data source 12, such as a television feed. Source 12 may be received by a decoder 14, which decodes the analog source signal and generates a plurality of digital bits. Conventionally, a plurality of bits are utilized to represent a value corresponding to an intensity level for a particular pixel to be displayed. This value is referred to as pixel data, an example of which is a binary number. The plurality of digital bits (binary numbers, for example) are sent from decoder 14 to a de-gamma block 15. De-gamma block 15 is operable to apply a de-gamma function to correct the television data that is conditioned to account for the non-linear response of a CRT image. Stated in other words, de-gamma block 15 is used to transform the data source from a non-linear space to a linear space, because a linear display system, such as a DLP system, does not use a CRT image. Image data processed by de-gamma block 15 is sent to a dither pattern generator 18, which operates to divide the image data into data representing multiple dither patterns. The dither patterns are to be shown one after another in a rapid succession within a predetermined frame time period, and a viewer perceives the successive showing of dither patterns as one complete image frame. Because a dither pattern is shown as one of the subframes of a frame, a dither pattern is also referred to as a subframe-level image or a subframe. The complete image shown by displaying the subframes within a frame time is referred to as a frame-level image, or a “super-resolution” image.

Referring again to FIG. 1, the dither patterns from generator 18 are provided to a formatter 20, which operates to assign pixel addresses to pixel data of each dither pattern. The address correlates the pixel data with a particular device, such as a particular mirror of a DMD™, that will be used to show the pixel according to the pixel data. Conventionally, the addressing scheme used to assign addresses is at a subframe level, which means that the same set of address values is used for each of the subframes. Thus, a first subframe and a second subframe may each have pixel data that has the same address. The data representing each dither pattern is sent to memories 24 and 28 to be stored. This data is then provided to a microcontroller 24 for displaying the subframes within a frame time period using a display 28.

Because of the non-linear nature of the gamma and the de-gamma curves, linear devices such as the DLP system may require finer resolution of approximately 14-16 bits of grayscale resolution at the lower end of the grayscale. However, some optical semiconductors such as DMD™, which uses a rectangular array of microscopic mirrors to modulate light, may have a grayscale resolution limit of 8-10 bits due to certain mechanical limitations associated with the speed in which mirrors can be tilted. To bridge the gap in resolution, mechanical and electronic dithering may be used to achieve the perception of 14-16 bit grayscale resolution.

Mechanical dithering refers to a technique where the micromirrors of a DMD™ are oscillated between multiple positions within a single frame time to achieve an increase in perceived resolution without increasing the array size. Because each discrete position allows the mirrors to be used for showing a different set of pixels, the rapid oscillation between positions increases the perceived resolution of an image by a multiple of the number of positions. For example, a rectilinear display may oscillate between four discrete positions for a quadruple increase in perceived resolution, and a diamond display may oscillate between two discrete positions to double the perceived resolution. Each position assumed by the mirrors during a particular frame time period may be used to display a subframe of an image.

Electronic dithering, such as Blue-Noise Spatial-Temporal Multiplexing (BN STM), refers to a technique where an image is divided into multiple portions each having a blue-noise dither pattern (also referred to as high frequency noise dither pattern). The multiple portions are shown in rapid succession within a frame time to show a complete image. Because one dither pattern is shown at a time and the patterns are shown in rapid succession, the perceived resolution of an image may be increased without increasing the actual array size. An image resulting from using both mechanical and electronic dithering may have unintended clumped portions, a high frequency noise, or a low frequency noise, which, depending on the situation, may lower the perceived quality of the image.

According to one embodiment of the invention, a system and method are provided that improve the quality of image shown using a DMD™ by synchronizing the electronic dithering with mechanical dithering, which allows control over the noise characteristic of an image shown in a frame time. In one embodiment, this is advantageous because the image perceived by a viewer is more pleasing to the viewer. In another embodiment, clumping is controlled, which improves the quality of the perceived image. Additional details of example embodiments of the invention are described in greater detail below in conjunction with portions of FIG. 1 and FIGS. 2 through 4.

Referring again to FIG. 1, formatter 20 includes a program 22 operable to assign pixel addresses to pixel data of dither patterns using an addressing scheme for a frame-level image rather than one for a sub-frame level image. For example, each binary number that represents each one of the pixels forming the dither patterns may be assigned an address from a set of address values for a frame-level image. Because an addressing scheme for a frame-level image is used to uniquely identify each pixel at a frame level, each binary number for each pixel of all dither patterns for a frame is assigned an address value that is unique among the assigned addresses of other binary numbers for other dither patterns of the frame. For example, in an embodiment where two dither patterns are to be shown in a single frame time, no binary number representing a particular pixel in the first dither pattern would be assigned the same address value as another binary number representing another pixel of the first or second dither patterns. An example of address values used in a frame-level addressing scheme is described below in conjunction with FIG. 2. By using a frame-level addressing scheme, each of dither patterns generated as a part of electronic dithering may be synchronized with a particular position of a mechanical dithering. This allows control over what dither pattern is shown as which subframe, which in turn allows each dither pattern to be designed to avoid clumping and undesirable noises in a resulting frame-level image. Referring again to FIG. 1, the addressed data is sent to memories 24 and 28 to be stored. The data is then provided to microcontroller 24 for controlling display on display 28.

FIG. 2 is a schematic diagram showing an example a plurality of pixels 50 each associated with an address value under a frame-level addressing scheme. In some embodiments, pixels 50 represent a frame-level image that may be shown using a portion of display 34 shown in FIG. 1. As shown in FIG. 2, in some embodiments, pixels 50 comprise thirty pixels 50 arranged in a five-by-six block. A plurality of blocks of pixels, such as the block of pixels 50 shown in FIG. 2, may be arranged so that the respective frame-level images formed by the blocks of pixels 50 together form a complete picture on display 34. In other words, pixels 50 shown in FIG. 2 represent a piece of a mosaic. Although pixels 50 are shown as a five-by-six block, any suitable configuration may be used to arrange any number of pixels 50.

Referring again to FIG. 2, each pixel 50 is associated with a frame-level address value, and program 22 of FIG. 1 may assign frame-level address values, such as the ones shown in FIG. 2, to each binary number representing associated each pixel of each dither pattern. Although examples of frame-level address values are shown as numbers from “0” to “29,” any suitable identifiers that can be used to distinguish one pixel address from other pixel addresses may be used.

Pixels 50 are arranged in rows, such as rows 56 and 60, and columns, such as columns 62 and 64. For example, as shown in FIG. 2, address values are addressed in raster scan order, with pixels 50 in row 58 addressed “0” to “4” from left to right, pixels 50 in row 60 addressed “5” to “9” from left to right, and so forth. However, in some embodiments, pixels 50 may be addressed in any suitable manner, and may be arranged in any suitable configuration that may be different than the example configuration shown in FIG. 2.

FIG. 3A shows pixels 80 that form a first dither pattern, and FIG. 3B shows pixels 100 that form a second dither pattern. FIGS. 3A and 3B are described jointly. In an example where a two-position, diamond mechanical dithering is used, pixels 80 shown in FIG. 3A may correspond to position one, and pixels 100 shown in FIG. 3B may correspond to position two. Position one is where the mirrors of a DMD™ are tilted downward by half of a pixel and position two is where the mirrors are tilted upward by half of a pixel. Each position assumed in mechanical dithering is used to show a subframe of an image, as described above. A dither pattern shown in a particular subframe constitutes a portion of the frame-level image. Thus, when all subframes are successively shown through the oscillation of mirrors between the two positions in a frame time, the viewer perceives the combined showing of the subframes as a frame-level image. According to some embodiments, pixels 80 for position one and pixels 100 for position two are addressed using two mutually exclusive groups of address values shown in FIG. 2, respectively. Thus, no pixel 80 shares the same address value as a pixel 100, and each address corresponds to a particular mirror that is assuming a particular position. For example, an address value shown as “1” in FIGS. 2 and 3A may correspond to a particular mirror of a DMD™ that is in a downward tilt position, and an address value shown as “6” in FIGS. 2 and 3B may correspond to the same mirror that is assuming an upward tilt position. In one embodiment, pixels 80 and 100 are respectively associated with odd and even address values shown in FIG. 2, which is one way of ensuring the assignment of unique address values. Because unique addresses are associated with for each one of pixels 80 and 100, pixel data for each pixel of the image to be displayed is uniquely addressed within an image space, such as the image space represented by pixel spaces 50 in FIG. 2. Because data for each pixel of a dither pattern is addressed using these unique addresses, as shown in FIGS. 3A and 3B, a dither pattern can be generated for each subframe to control the noise characteristics of each dither pattern and to reduce the clumping that may result from showing multiple subframes.

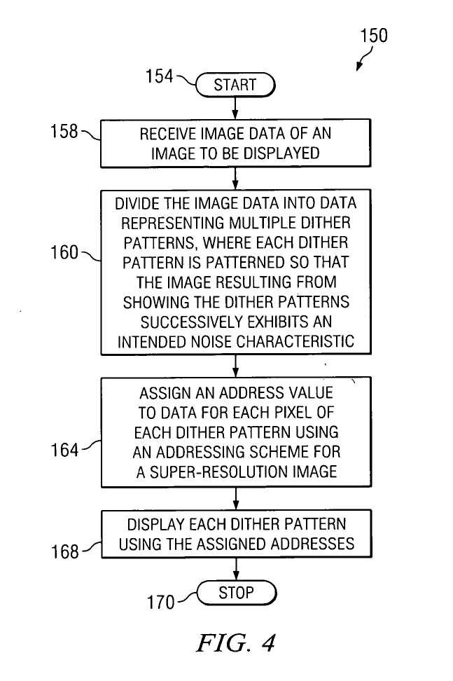

FIG. 4 is a flowchart illustrating one embodiment of a method 150 for displaying an image. Method 150 is described using pixels 50, 80, and 100 shown in FIGS. 2, 3A, and 3B, respectively. However, any pixels and any suitable frame-level addressing scheme may be used. Program 22 shown in FIG. 1 is used as an example implementation of some portions of method 150. However, any suitable software or hardware implementation method may be used. Method 150 may be used with any electronic and mechanical dithering techniques, including the two-way and four-way optical movements.

Method 150 starts at step 154. At step 158, image data of an image to be displayed using display 34 is received at decoder 14 shown in FIG. 1. The image data may be processed suitably at decoder 14, and the processed image may undergo gamma correction at device 15. At step 160, the processed and corrected image data is divided into data representing multiple dither patterns at generator 18 shown in FIG. 1. Each dither pattern is to be displayed as one of the subframes that will be displayed by display 34 within a frame period. In some embodiments, the image data is divided into data representing multiple dither patterns so that each dither pattern includes a high frequency noise or a low frequency noise. In some embodiments, each dither pattern for the image to be displayed may be patterned so that the image resulting from the combined viewing of the subframes has a high frequency noise or a low frequency noise regardless of whether an individual dither pattern exhibits a high or low frequency noise. Thus, depending on the particular noise characteristic that is desired for a particular type of image (bright, dark, fast motion, or standstill image, for example), it is possible to control the noise characteristic of each of the subframes and/or other characteristics of the frame-level image.

At step 164, program 22 assigns an address value to pixel data, such as a binary number, for each pixel of each dither pattern using a frame-level address scheme, an example of which is shown in FIG. 2. Using frame-level address values allows each dither pattern to be patterned so that the resulting outcome of showing all of the subframes within a frame period can be controlled to have either a high frequency noise characteristic or a low frequency noise characteristic. At step 168, each dither pattern is displayed as a subframe using the assigned addresses of step 164. Method 150 stops at step 170.

Although some embodiments of the present invention have been described in detail, it should be understood that various changes, substitutions, and alterations can be made hereto without departing from the spirit and scope of the invention as defined by the appended claims.

What is claimed is:

1. A method for displaying an image, comprising:
providing a digital micromirror device having a plurality of micromirrors operable to oscillate between a plurality of positions;
receiving a plurality of binary numbers each indicating a light intensity level for a particular one of a plurality of pixels that form a plurality of dither patterns, wherein each dither pattern is a particular portion of the image to be displayed;
assigning, to each binary number, an address that is unique among the addresses assigned to each of the plurality of binary numbers, wherein the address identifies a particular one of the plurality of micromirrors in a particular position; and
displaying the dither patterns one after another in a predetermined frame time period using the digital micromirror device by showing each pixel on a display according to the binary number representing the pixel, the each pixel shown using the particular one of the micromirrors in the particular position identified by the address assigned to the binary number.

2. The method of claim 1, wherein each dither pattern is configured so that the image, when shown by displaying the dither patterns one after another in the frame time period, comprises a high frequency noise.

3. The method of claim 1, wherein the plurality of positions comprises only two positions, and the plurality of dither patterns comprises only two dither patterns.

4. The method of claim 1, wherein the plurality of positions comprises only four positions and the plurality of dither patterns comprises only four dither patterns.

5. A method for displaying an image using a digital micromirror device having a plurality of mirrors operable to assume a plurality of positions, the method comprising:
receiving a plurality of numbers representing a respective plurality of pixels that form a plurality of dither patterns, wherein each dither pattern is a particular portion of the image to be displayed and each pixel is represented by a particular number;
assigning, to each number, an address identifying a particular one of the plurality of mirrors in a particular position, the address being unique among the addresses assigned to each of the plurality of numbers; and
displaying the dither patterns one after another in a predetermined frame time period using the digital micromirror device by showing each pixel on a display according to the number representing the pixel, the each pixel shown using the particular mirror in the particular position identified by the address assigned to the number.

6. The method of claim 5, wherein each dither pattern is configured so that the image, when shown by displaying the dither patterns one after another in the frame time period, comprises a high frequency noise.

7. The method of claim 5, wherein each dither pattern comprises a high frequency noise.

8. The method of claim 5, wherein the plurality of dither patterns comprises only two dither patterns.

9. The method of claim 5, wherein the plurality of dither patterns comprises only four dither patterns.

10. The method of claim 5, wherein the plurality of numbers comprises a plurality of binary numbers representing a particular level of light intensity.

11. The method of claim 5, and further comprising:
receiving an image feed representing the image in analog format; and
converting the image feed into the plurality of numbers.

12. The method of claim 5, and further comprising:
receiving an image feed representing the image in a format that is used for displaying the image using a cathode ray tube;
applying a de-gamma correction to the image feed; and
converting the corrected image feed into the plurality of numbers.

13. The method of claim 5, wherein the address corresponds to a unique location on the image.

14. A system for displaying an image using a digital micromirror device having a plurality of mirrors operable to assume a plurality of positions, the system comprising:
a processor;
a computer readable medium accessible to the processor and storing a program operable, when executed by the processor, to:
receive a plurality of numbers representing a respective plurality of pixels that form a plurality of dither patterns, wherein each dither pattern is a particular portion of the image to be displayed and each pixel is represented by a particular number;
assign, to each number, an address identifying a particular one of the plurality of mirrors in a particular position, the address being unique among the addresses assigned to each of the plurality of numbers; and
display the dither patterns one after another in a predetermined frame time period using the digital micromirror device by showing each pixel on a display according to the number representing the pixel, the each pixel shown using the particular mirror in the particular position identified by the address assigned to the number.

15. The system of claim 14, wherein each dither pattern is configured so that the image, when shown by displaying the dither patterns one after another in the frame time period, comprises a high frequency noise.

16. The system of claim 14, wherein each dither pattern comprises a high frequency noise.

17. The system of claim 14, wherein the plurality of dither patterns comprises only two dither patterns.

18. The system of claim 14, wherein the plurality of dither patterns comprises only four dither patterns.

19. The system of claim 14, wherein the plurality of numbers comprises a plurality of binary numbers each representing a particular level of light intensity.

20. The system of claim 14, and further comprising a decoder coupled with the processor, the decoder operable to:
receive an image feed representing the image in analog format; and
convert the image feed into the plurality of numbers.
